(19) United States
(12) Patent Application Publication
(10) Pub. No.: US 2002/0054080 A1
(43) Pub. Date: May 9, 2002

(54) Internet service controller with real time status display

(76) Inventors: David Gerald Belanger, Hillsborough, NJ (US); Charles Douglas Blewett, Madison, NJ (US); Yin-Farn Robin Chen, Bridgewater, NJ (US); Stuart H. Gannes, Palo Alto, NJ (US); Misha Pavel, Portland, OR (US); Chung-Hwa Herman Rao, Taichung (TW); Gary L. Zamchick, Tenafly, NJ (US)

Correspondence Address: Samuel H. Dworetsky, AT&T CORP., P.O. Box 4110, Middletown, NJ, 07748-4110, US

(21) Appl. No.: 09/882,440

(22) Filed: Jun. 15, 2001

Related U.S. Application Data
(60) Provisional application No. 60/211,680, filed on Jun. 15, 2000.

(51) Int. Cl. G09G 5/00

(52) U.S. Cl. 345/738

(57) ABSTRACT

A system and method is provided for retrieving information on a network and displaying the information on a personal computer or other visual display device. A proxy multiplexor opens connections with each of a plurality of service providers and exchanges authentication information such as a user ID and password with each of the service providers by retrieving and forwarding cookies containing the authentication information. Updated status data from the service providers is displayed within icons representing each of the service providers.

### FIELD OF THE INVENTION

This invention relates generally to the provision and display of information, and, in particular, to a system and interface on a personal computer (PC) or other visual display device, which aggregates multiple services from multiple service providers and is periodically updated to include current up-to-date information related to items that interest the user.

### BACKGROUND OF THE INVENTION

The Internet has considerably improved the accessibility of information or “content” for users on a global scale. Specifically, the Internet's World Wide Web (WWW) allows a user to access a universe of information that combines text, audio, video, graphics and animation within a hypermedia document. Initially, the WWW was developed to provide researchers and scientists with a system that would enable them to quickly access all types of information with a common protocol. Recently, the general public has embraced the WWW as the ideal forum for accessing and distributing all types of content such as in the entertainment, business, legal, medical and related areas. Communication with others on a worldwide scale has also dramatically improved with the advent of improved electronic mail, mess aging and conferencing services.

While this global access to almost limitless content and communication on the WWW has its obvious benefits, it also has some serious shortcomings. The sheer number of different content and service providers and the peculiarities of each distinct system can make accessing and utilizing the Web extremely difficult. Different systems have different launching, accessing, browsing and authentication procedures that can make even a simple login procedure somewhat cumbersome. Furthermore, the content on the WWW is ever changing requiring a user to constantly log in to check on updates and verify the status of information or communications.

Accordingly, it would be desirable to have a system and user interface by which multiple information, content and service providers may be easily accessed and viewed on a user's display on a real time basis.

### SUMMARY OF THE INVENTION

The present invention provides a service controller system with real time status updates. The system includes a plurality of information and service providers, such as electronic mail providers, messaging systems, content providers and the like. This plurality of information and service providers is in communication via the Internet with a proxy multiplexor that collects and aggregates information and content from these plurality of information and service providers. The information and content received by the proxy multiplexor is transmitted to an end user service control component that includes a display portion having a plurality of service provider icons therein. Each icon represents a unique information and service provider that the user has selected.

In one embodiment of the present invention, each of the icons includes a real time status display for updating the user on a real time basis. The end user service control component is operated in cooperation with the user's browsers through which new services may be created and existing services viewed and modified. Through the end user service control component, services may be launched simply by clicking on the icon associated with the service the user wishes to access. A single authentication procedure is implemented for the user through the system so that multiple authentication steps are unnecessary.

In the present system, the user is updated as to status changes within each service represented in the end user service control component. The user may be updated as to changes in news, as to new electronic mail messages, stock quote updates, buddy lists and any number of information sources the user has specified. Updating may be done by simply providing to the user information within the end control module or the updating may be performed more actively such as by alerting the user by visual and/or audio alerts within the system.

One embodiment of the invention includes a computer readable medium having a computer program encoded thereon. The medium includes at least three portions. A first portion contains a program segment for facilitating the selection of preferences for information to be displayed as part of a service controller. A second portion contains a program segment for receiving over a communication network information from a plurality of service providers in accordance with the selected preferences. Finally, a third portion of the medium contains a program segment for displaying the information within the service control component. In the display, at least one of the plurality of service providers is represented in the service control component by a unique icon that includes real time status updates.

In that embodiment of the invention, a proxy multiplexor may aggregate the information received from the plurality of service providers. The service control component may configured in conjunction with a browser. It may be an embedded control bar, or may be an independent display object. The unique icon may be selectable by the user to retrieve additional information from a corresponding one of the service providers.

In another embodiment of the invention, a service controller system for integrating information from a plurality of service providers includes a proxy multiplexor that receives information from the plurality of providers. The proxy multiplexor aggregates the information from the plurality of providers. The system also includes an end user service control component that receives information from the proxy multiplexor. Each respective service provider is represented by an individual icon within the end user component, and at least one of the icons displays the most current information received from its associated provider.

At least one of the plurality of providers may be an HTTP server. The end user component may integrated as part of a browser, or may be a stand-alone object. The system may permit new providers to be added for display in the user's end user component via a centralized server, which may be an HTTP server having SSL capabilities.

The service controller system may further include a second end user component having individual icons representing other service providers. In that case, both end user components receive information from the proxy multiplexor. Furthermore, the individual icons may be selected to retrieve additional information from the corresponding service providers.

One embodiment of the invention is service controller system that includes a plurality of service providers that provide information and content to a plurality of users. A proxy multiplexor for each of the plurality of users receives information and content from the plurality of providers. Each proxy multiplexor aggregates the information and content from the plurality of providers for each user. The system also includes an end user control component that continuously receives updated information and content from the proxy multiplexor. Each respective provider is represented by an individual icon within the end user component, and each individual icon is updated whenever new information is provided from the respective service provider associated with that icon.

The end user component of that system may include a display portion that contains the provider icons. The end user component is integrated as part of a Web browser, or may be a stand-alone display object. The system may permit new providers to be added for display in the user's end user component via a centralized server, which may be an HTTP server having SSL capabilities. The proxy multiplexor may be an executable running on a user's machine. Each individual icon is updated without action required of the user, and may provide an alert to the user when updated with new information.

In yet another embodiment of the invention, a method for displaying content from a plurality of service providers as part of a service control component includes receiving a selection of preferences from a user for receiving and displaying the content. The content is then received over a communication network from the plurality of service providers in accordance with the preferences. The content is then displayed in accordance with the preferences. The service providers are represented in the service control component by unique icons that include real time updates including at least some of the received content.

These and other advantages of the invention will be apparent to those of ordinary skill in the art by reference to the following detailed description and the accompanying drawings.

### BRIEF DESCRIPTION OF THE DRAWINGS

FIG. 1 illustrates an exemplary configuration of a user service controller and launcher in accordance with the teachings of the present invention.

FIG. 2 is a block diagram illustrating the operation of the user service controller in accordance with the teachings of the present invention.

FIG. 3 is a block diagram illustrating the operation of the proxy multiplexor in accordance with the teachings of the present invention.

FIG. 4a illustrates an exemplary user service controller in accordance with the teachings of the present invention.

FIG. 4b illustrates a more detailed view of the exemplary user service controller in FIG. 2a.

FIG. 5 illustrates another embodiment of a user service controller in accordance with the teachings of the present invention.

FIG. 6 illustrates an exemplary login screen for use with the present invention.

FIG. 7 is a block diagram illustrating a method for initiating a new service according to one embodiment of the invention.

### DETAILED DESCRIPTION

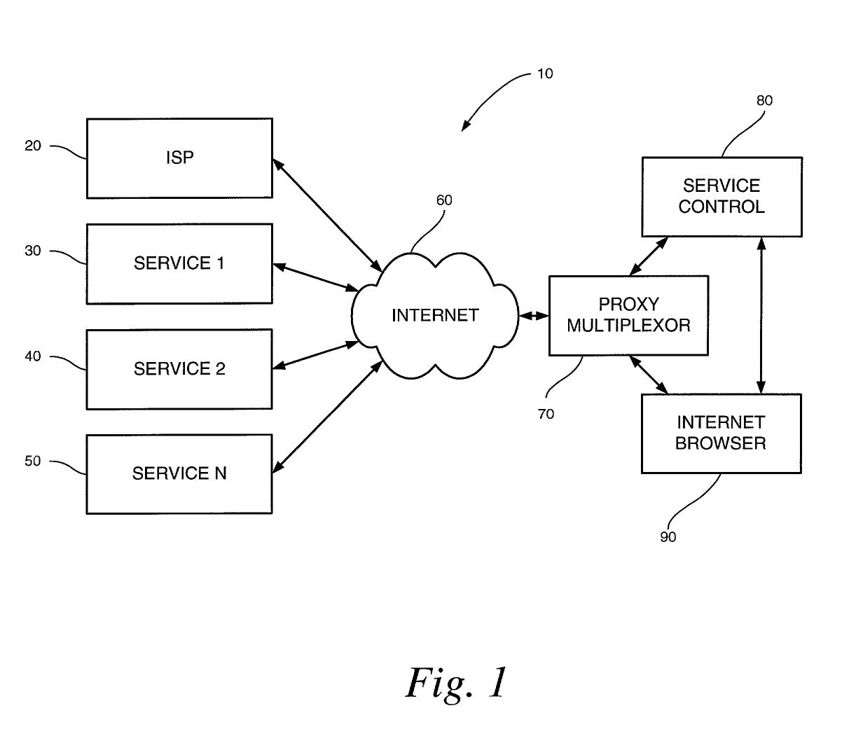

Referring now to FIG. 1, there is shown an exemplary configuration of a service control system 10 in accordance with the teachings of the present invention. The service control system 10 integrates personalized information obtained from a variety of user-specified services and information providers. The user-specified services and information providers may be one of any number of content providers, ISP's, Websites, electronic mail providers, networking, remindering, authenticating and other Internetrelated services. The service control system 10 provides up-to-date real-time information directly to the user without requiring the user to navigate through a series of different authentication, accessing and networking steps. The present invention provides easy accessibility and browsability of different databases of services and applications, direct launching of applications and services, administers unified authentication to various services, facilitates provisioning of new services, allows dynamic control of a wide variety of communication devices and systems, provides continuous status indication of various services and provides alarms and alert signaling of important user-specific events.

Referring again to FIG. 1, the system includes a plurality of service providers 20, 30, 40 and 50, a communication network 60, such as the Internet, a proxy multiplexor 70, an end user service control component 80 and a browser 90. In the preferred embodiment, the end user service control component 80 is code running within the browser 90. Alternatively, the service control component may be a stand-alone executable running on a user machine. The service providers can be operated by individual companies/entities, one of which can be the ISP 20 that is providing the local access service to a user. The other service providers may be providers of any type of information and content, and/or providers of communication and message management services, such as electronic mail, chat, instant messaging, network authentication, alerting, remindering and other related services. Typically, those service providers are implemented on servers supporting conventional public transport layer network protocols such as Hypertext Transfer Protocol (HTTP) (see R. Fielding et al., “Hypertext Transfer Protocol—HTTP/1.1,” IETF RFC 2616, Networking Group, 1999, which is incorporated in its entirety by reference herein) and Simple Mail Transfer Protocol (SMTP), and/or supporting proprietary protocols such as AOL's Instant Messaging Protocol (AIM). Such servers typically support secure socket layer (SSL) encoding (see Freier et al., “The SSL Protocol Version 3.0,” IETF Internet Draft Specification (November 1996), found at http//home.netscape.com/eng/ss13/index.htm1, which is incorporated in its entirety by reference herein). Status messages from each of the service providers are passed or “pushed” to the proxy multiplexor 70 and then passed on to the end user service control component 80. If the service is run as a URL, then the corresponding server can also be used to support that traffic. In one embodiment of the invention, at least one of the service providers is a server for administering the system of the present invention. That server may handle the provision and creation of services for each individual user as well as other administrative functions such as password and authentication control.

In the present invention, the proxy multiplexor 70 assembles and integrates the data and information received from the plurality of service providers 20, 30, 40 and 50. In a preferred embodiment, the proxy multiplexor 70 is a separate executable running on the end user's machine. In other embodiments, the proxy multiplexor 70 may be centrally located such as on a remote central server or even coupled with the system server as discussed above. In the present invention, the proxy multiplexor 70 controls the flow of information, such as status of messages and electronic mail, to the service control component 80, which is eventually forwarded to each user's personal service control display within the service control component, as discussed in more detail later herein. The proxy multiplexor will also handle user authorization duties for each respective service/provider represented in the service control component. Typically, the proxy multiplexor 70 will receive data sent using HTTP or another data transfer protocol by each respective service/provider. The proxy multiplexor 70 will be in communication with the service control component so as to provide any update information or data to the service control component. In the service control display, each of the service/provider icons can then be animated and/or visually updated by the changes provided from the services/providers.

Connections between the proxy multiplexor 70 and the respective service providers 20-50 are established by opening network connections in accordance with the network protocol being used; e.g. HTTP. Those connections, as well as the connection between the proxy multiplexor and the service control component 80, occupy open file descriptors/sockets available within the user machine environment. If the number of available open file descriptors/sockets required to connect to the selected services is in excess of the maximum permitted by the user machine environment, some or all of the services will be opened, monitored and closed in accordance with the method described below.

The proxy multiplexor may also handle “cookie” requests in the network traffic to the user's browser. Those requests are used to handle the equivalent of user login to the service. Preferably, most network traffic will be encrypted using SSL or other similar encryption techniques.

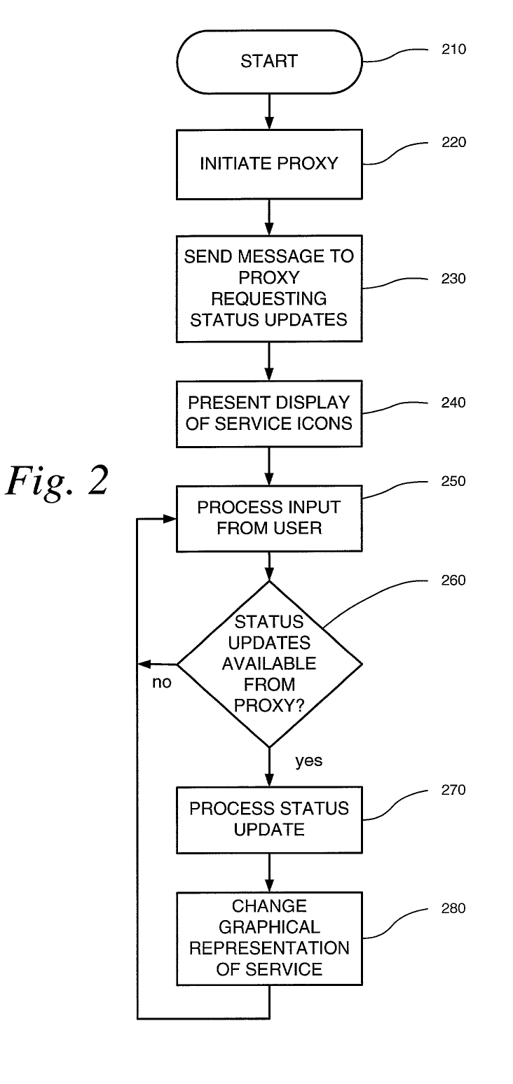

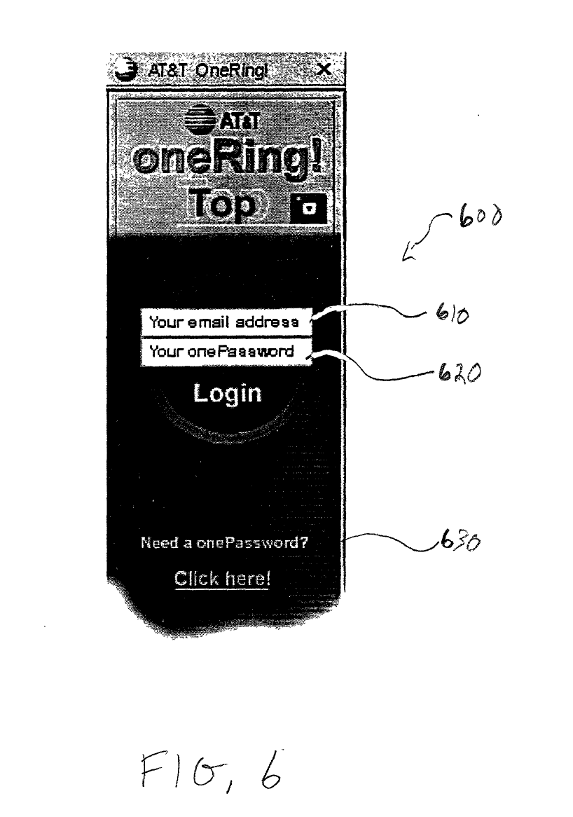

Referring now to FIG. 2, a process is described wherein the end user service control component monitors incoming data and updates its display accordingly. The service control component is started (step 210) either by manual invocation by the user, or automatically as part of a user machine start-up script or other automatic launching. Where the service control component is part of the browser, it may be started automatically upon start-up of the browser or start-up of the operating system. The user control component may require user input of a single password as described below with reference to FIG. 6.

The service control component initiates the proxy at step 220. If the proxy is not yet running and is installed to run on the local user machine, the service control component launches the proxy. If the proxy is to run on a remote machine, the service control component tests the connection to the proxy and verifies that the proxy is running and ready to receive commands.

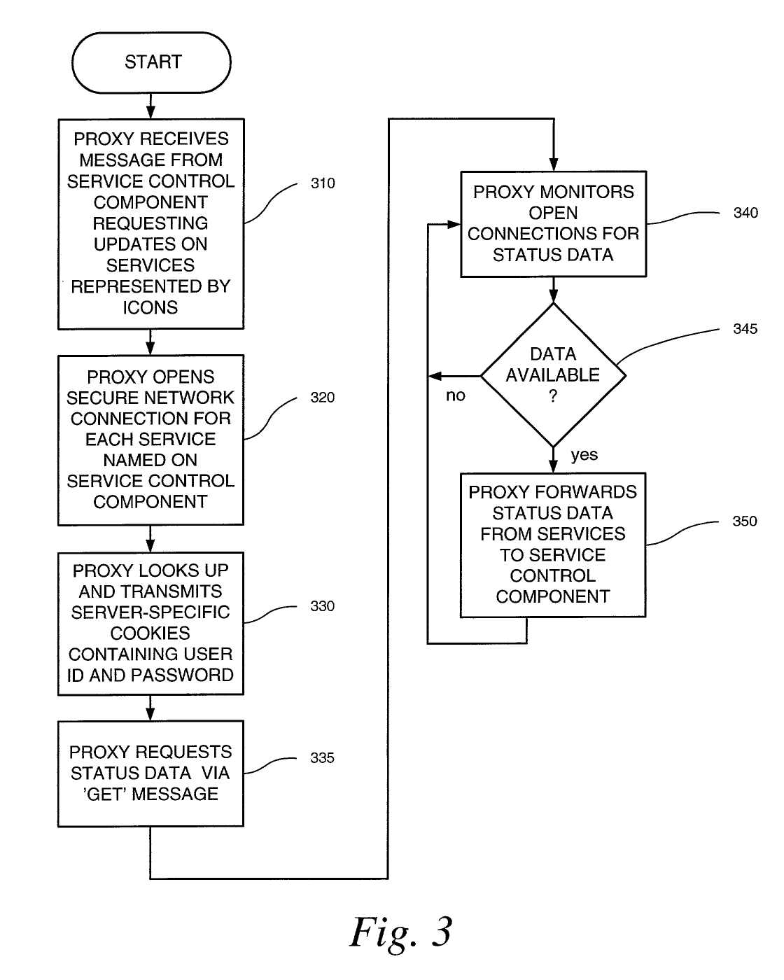

Once communication with the proxy is established, the service control component sends a message to the proxy at step 230 requesting that the proxy get status updates from the services to be represented by the icons in the user interface. In response to the request from the service control component, the proxy sends messages to each of the represented services as described below with reference to FIG. 3, verifying the user's identity and receiving an initial set of status data to be displayed by the service control component. The proxy then forwards that status data to the service control component, which displays the icons (step 240) including the status data.

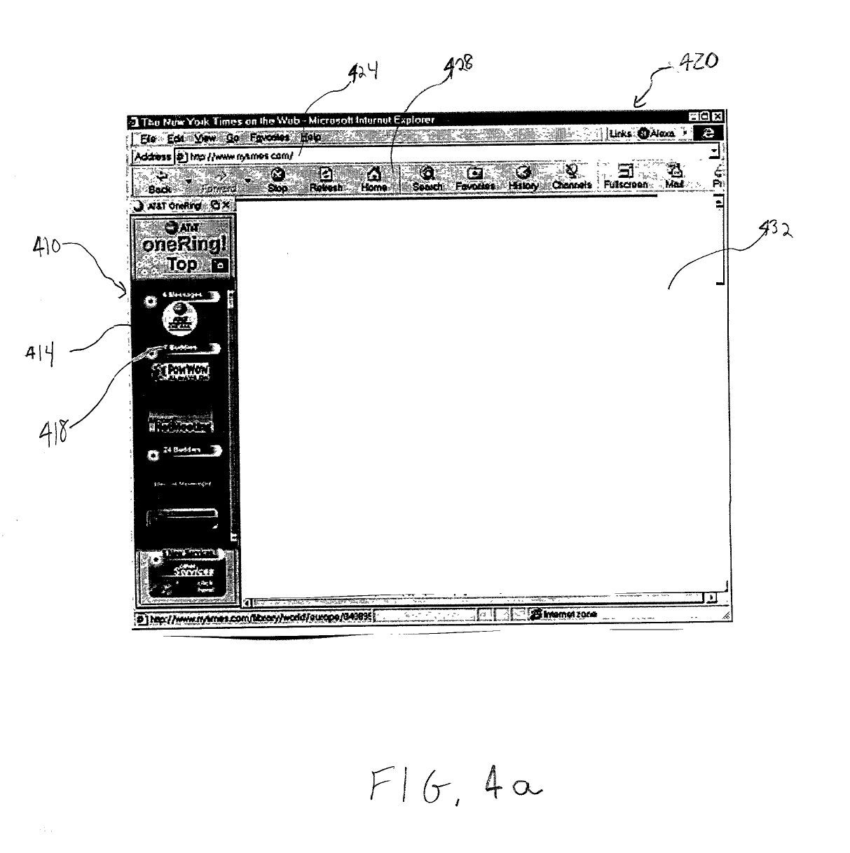

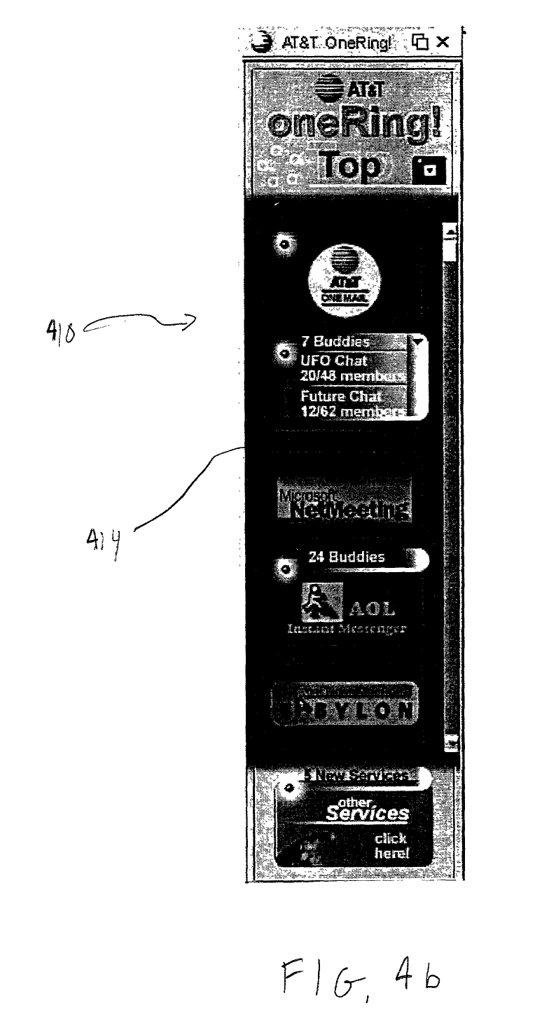

The service control component processes any input received from the user at step 250. One or more defined user actions will have predictable results within the service controller. For example, if an icon in the end user controller is “left-clicked”, the icon is selected. If the icon is left “double-clicked”, the service represented by the icon is launched and can then be viewed within, for example, the active window region 432 (FIGS. 4a and 4b) of the browser. If the icon is right clicked, a listing of relevant operations such as “delete, preferences and change display” may be provided and if the icon is “moused-over”, a display of help, general and real-time status display may be provided to the user. Furthermore, the icons may be dragged and dropped within the service controller display or the icons may be switched between other instances of the service control component, such as a “tom-off” instance of the service control component. As used herein, a “torn-off” instance is an instance created by performing a “drag and drop”-like operation with a pointing device such as a mouse. The operation creates a new, free-standing copy or instance of the service control device.

The service control component continuously checks for status updates (step 260) that may become available from the proxy. If no updates are available, the service control component continues looking for user input (step 250) and for status updates from the proxy. If a status update is available, the service control component processes that data (step 270) and changes the graphical representation of the service (step 280) in accordance with the processed update data. For example, in the case of a service icon displaying stock prices, the prices displayed within the icon would be changed according to the update data. Processing and displaying may also include such functions as showing the prices in red if the price has decreased and showing the price in green if the price has increased. After the graphical representation of the service has been updated, the service control component returns to looking for user input (step 250) and for status updates from the proxy (step 260).

In an exemplary method according to the invention shown in FIG. 3, a proxy processes a status request from the service control component and returns updated data. The proxy receives a message (step 310) from the service control component to update the status data. The message may contain a list of URL's or other addresses of the services represented by icons in the service control component's user interface. If no network connection previously exists, the proxy opens a secure network connection to each of the named service providers (step 320). In the case where HTTP1.1 protocol or a later version is being utilized, the network connection remains open to receive multiple HTML pages or other data formats containing status update data. The connection furthermore preferably utilizes HTTPS (secure HTTP) protocol.

In a preferred embodiment of the invention, personal administrative data to be exchanged with the service providers are stored in “cookies” that are accessible to the proxy. The proxy administers a file containing cookies received from the individual service providers as well as one or more cookies created by the service control and containing personal data in a specific format for use in signing up with a new service. The proxy looks up one or more service-specific cookies (step 330) containing a user name and password that are used by the user in accessing an individual service. Because that cookie is specific to an individual service provider, a service provider may establish user names and passwords according to its own policies, and need not conform to generic standards established by the service control. Because the user name and password are stored as cookies accessible to the proxy, the user need not enter that data each time the service is accessed, allowing the user to conveniently access and keep updated a large number of services as represented by the icons in the user interface. Once the proxy locates a cookie, that cookie is transmitted via the HTTPS connection to the service. In accessing and transmitting the cookies for a particular service, the proxy actively shields activity pertaining to that service from the other services. As the services receive the ID and password cookie(s), the services verify the identity of the user and may notify the proxy of that verification. If the ID and password are found to be missing or invalid, the service provider may deny access and return to the proxy a message indicating that the user account is expired, unknown, closed, etc.

The proxy at step 335 sends a secure HTTPS request to each selected service via an HTTPS “GET” message, requesting updated status data. The request may be in a form that is standardized among the service providers, although the request may alternatively be service-specific so that special content or formatting unique to a service provider may be requested. For example, a request to a stock quotation provider may contain the individual stock symbols for which a quote is to be displayed. In another example, a request to a weather service may contain a location of the weather forecast desired.

After updated status data has been requested, the proxy at step 340 monitors the network connection to the service provider for updated information. If no updated status data is available (step 345), the proxy continues to monitor the open network connection(s). If updated status data is available, the proxy forwards that data to the service control component (step 350) for display in the corresponding icon.

In a preferred embodiment of the invention, a user may select a particular icon within the service control component user interface in order to display additional information from the corresponding service provider. For example, a user may select the weather service provider to display an HTML page from which a weather map is accessible. Upon selection of an icon by the user (by, e.g., double clicking), the proxy sends a message to the service provider through the already-open network connection requesting additional information (e.g., the service provider's home page). That information is preferably received and displayed to the user by a browser residing on the user's machine. The user may then interact with the service provider using standard browsing techniques such as selecting HTML buttons or transmitting entered data to the service provider.

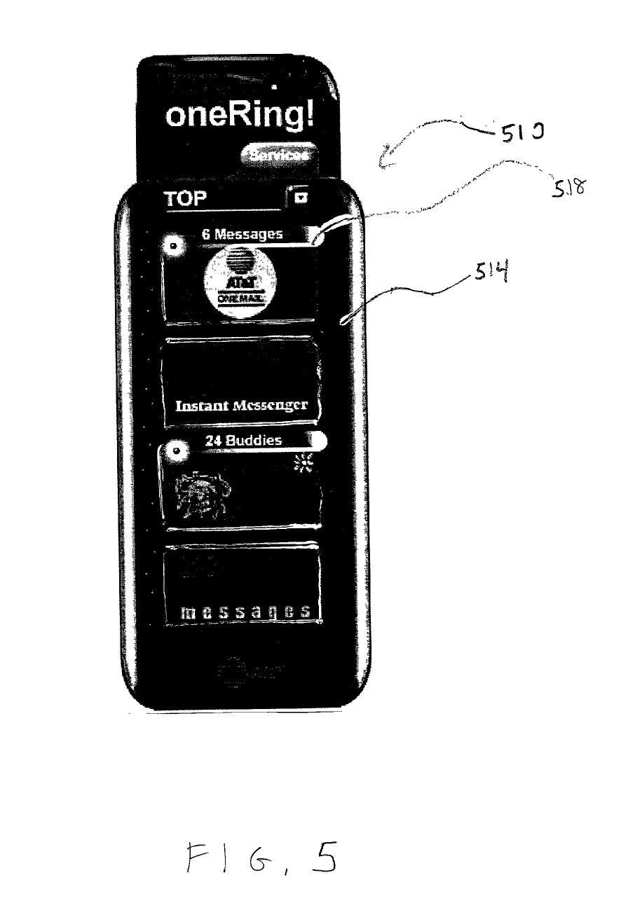

Referring to FIGS. 4a and 4b, the end user's service control component may be run as a sidebar attached to the user's browser, or as an independent graphical device or object as shown in FIG. 5. In a preferred embodiment, the user's service control component 410 includes a display portion 414 that contains a number of icons, such as icon 418, each of which represents one or more distinct service providers, such as providers 20, 30, 40 and 50 shown in FIG. 1. Clicking on one or more of the service icons within the end user service control component display 414 will activate and/or launch the respective service represented by the icon. In the end user service control component, services may be represented by URLs or they may executable files. If the service is represented by a URL, the URL is passed to the user's preferred browser. If the service is an executable file, then the program is simply run or executed on the user's machine.

Referring again to FIGS. 4a and 4b, the service controller 410 is integrated within a generic World Wide Web (WWW) browser 420. The browser 420 typically includes a location active region 424 where the URLs appear and may be edited or typed. Below the location active region 424 is a row of interactive buttons 428 that help navigate the WWW, and below the row of interactive buttons 428 is the active window portion 432 of the browser 420. Active window portion 432 is where Web pages, e.g. hypertext markup language files, are displayed. Most hypertext markup language files have interactive regions, usually highlighted and/or underlined text or graphics, which if selected send a request to an attached server for a next HTML file of information. The respective service providers selected by the user may be viewed and accessed within the active window portion 432. In a preferred embodiment of the invention, the browser is also used in the provisioning process for the creation of new services, such as through a dedicated HTTP service provider. Newly announced services may be displayed in the active window portion 432. Selecting those services may result in a tour of the service being “played.”

Referring again to FIGS. 4a and 4b, adjacent to the active window portion 432 is situated the service controller display 414. As shown, a plurality of icons 418 is contained within the display area of the service controller, preferably without interfering with or covering each other. Each of the display areas contains different information, relating to topics selected by the user, including, in this example, AT&T One Mail, an Instant Messenger service, and other messaging services. The information displayed in the display areas is up-to-date, since it was recently obtained from the respective service/provider, as discussed later herein, and it is customized, in that the information within each of the areas was selected by the user and set forth in his or her profile. As the data is updated, the service controller remains active and is not interrupted. Numerous variations of the service control display as an attached bar are possible; for example, the service controller display may be configured to be overlaid upon the active window portion 432 of the browser 420 or the service controller may be placed at the top, bottom, or right side of the user's screen as desired by the user. The service control display may also be an independent top-level window as described below with reference to FIG. 5

Within the service controller display 414, the service provider icons 418 perform a number of functions for the end user, namely, each icon will identify the availability of the respective service to the user, launch the associated service represented by the icon and display in real time the status of the associated service. The icons respond to defined actions as described above.

In the present invention, each icon provides a real time status display of information selected by either or both the service provider and user. A user may be alerted to information within each service provider by one or more animated configurations of an icon. For example, “roll over”, “drag and drop” and “status” animations may be used within the system to designate a change in state within the system, such as new timely updates to an icon's information and/or to draw attention to the critical aspects of a task. For example, the “roll over” animation may be used to identify when the user's cursor enters the active zone of the icon. If the cursor hesitates over the field of the icon, a small window will display which has a brief description of the service or a status detail. The “drag and drop” animation indicates that a specific icon has been grasped and is being dragged by a user. The “status” animation may be used as event messages that interrupt the user at a level of intrusion determined user settings and by the urgency of the alert, such as if the user has received new electronic mail or the user's “buddy” is online. Some of those messages may be delivered without any behavior required on the part of the user. For example, information displayed within an icon may be automatically updated, or the messages may be delivered in an alert fashion, such as by having the system beep or alert the user in some other fashion as to the message. In another example, an icon in the system may flash intermittently if a person specified by the user has just logged on to the Internet.

Referring now to FIG. 5, the end user service control component may be run as an independent device-like object or stand-alone application that may be opened on a user's desktop or display device. In a preferred embodiment, the end user service control component 510 includes a display portion 514 that contains a number of icons, such as icon 518, each of which represents one or more distinct service providers, such as providers 20, 30, 40 and 50 shown in FIG. 1. Clicking on each of the service icons within the display portion 514 will activate and/or launch the respective service represented by the icon. In the end user service control component 510, a service may be represented by URLs or it may be an executable file.

In one embodiment of the present invention shown in FIG. 6, the service control system may also include an authentication component via a unified password system. In the present invention, a unique identity is created for each user of the service controller system. Thus when a user wishes to log in to any of the services in her personal portfolio, she will not have to explicitly log in to different services, using a variety of different paths. The user will simply have to use her system password to interface with each of the different service providers. For example, in an exemplary display 600, the user is allowed to use her electronic mail (email) address 610 as her login ID along with a single password 620 to access any one of the many services accessible from her respective service control component. A user's single password may be chosen by a user by clicking on the link “Click here!” 630 that may be associated with a system server 20 as previously discussed herein. In a preferred embodiment where a user operating system requires a login ID and password, the service control uses that authentication as authentication for the service control.

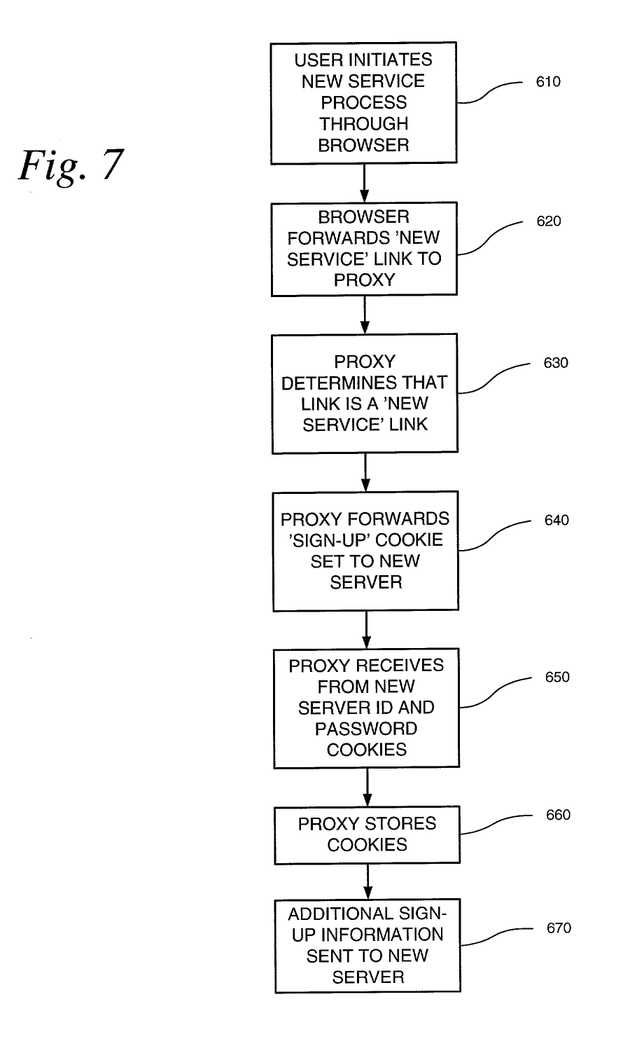

In another aspect of the invention, a user may initiate or “sign up” for a new service as shown in FIG. 7. Links to new services may be presented to the user through a services announcement page that appears each time a user opens the service controller. Alternatively, the links may be presented to the user as pop-up pages presented according to some marketing or other plan. An advantage of the present invention is that accounts with new services may be initiated without tedious input of personal sign-up data in the particular format required by the new service provider; instead, such data is stored once in a format recognizable to all available service providers, and transmitted to each service provider in the “sign-up” procedure described below.

To sign up for a new service, a user selects that service (step 610) through the browser using a “sign-up” or “new service” link found in a services announcement page or elsewhere. The browser at step 620 forwards the new service link to the proxy. The proxy is able to identify the link as a new service link by finding it in a look-up table, by filtering for identifiers contained in the link, or by having the service return a redirect link forcing another page to be loaded. The proxy is therefore able to determine (step 630) that the link is a new service link and to treat the new service link differently from other links forwarded to it by the browser.

The proxy at step 640 retrieves and forwards a “sign-up” cookie to the new service provider together with an HTTPS request. The sign-up cookie contains data identifying the proxy as a legitimate proxy offering the service to a user through a service controller system. In response, the new service provider at step 650 sends to the proxy one or more cookies containing the ID and password to be used by the user in accessing the new service. Those cookies are stored at step 660 by the proxy for use each time the service is used by the user.

The proxy at step 670 retrieves one or more user data cookies and forwards them to the new service provider. The user data cookie(s) contains the user's personal data needed by the new service provider to open a new account with the user. In the preferred embodiment, all available service providers have agreed to a standard format in which the user's personal data is contained in the user data cookie. For example, the cookie may contain the user's name, home address, billing address, email address, and a payment method such as a credit card. In that way, the user is not required to retype and submit that information each time the user registers for a new service.

An instance of the service control component may be opened by a user by, for example, double-clicking an icon. Alternatively, an instance of the service control component may be opened automatically when the browser is opened, or when a user machine is booted. Furthermore, as is known in the art, a user may create additional instances of the control by “tearing off” graphics provided for that purpose using a pointing device. Each instance of the control as used herein includes a number of unique icons representing service providers, and each instance contains a page number differentiating it from other instances of the control. Only one copy of a particular page may be visible, so only one icon for each service provider is visible at any time. Multiple instances of the control on a single screen share code and share a single socket connection to the proxy.

When an instance of the service control containing a page of service provider icons is opened, the service control sends a message to the proxy as described above requesting updates on the services represented by the icons. In response, the proxy opens an HTTP1.1 connection for each such service, requests status updates and then monitors the open connections for status update data. As defined herein, information in an icon that is updated as information becomes available from the service provider is updated in “real time.”

It is possible that the number of available open file descriptors/sockets as defined by the user's operating system may be insufficient to handle connections to all service providers appearing on all instances of the service control. In that case, connections to certain service providers must be closed while other service providers are monitored for updated information. As currently implemented, pages of services are closed at predetermined time intervals. The intervals may be hard coded or may be set by the user.

Various strategies may be implemented for determining which page to close as new socket connections are required. In a currently preferred embodiment, the first and several of the last pages to be accessed are never closed, and a page from the remaining pages is randomly selected and closed each time a page is needed. In that way, the first page, which is often an important page, and the last few pages, which are often the most currently relevant, are updated as often as possible.

Generally speaking, a user may utilize the present system to organize, arrange, access and launch service providers in any number of fields such as electronic mail, traffic, weather, financial information, entertainment information, etc. Other information may also be provided, depending upon the types of information that are available from information providers and thus can be offered to users of the system. Typically, each user will create his own personal “profile” specifying (a) the categories or types of information services that are to be provided to that user, and (b) for those information services, the parameters that are associated with the desired information. For example, a first user may desire traffic, financial and sports information, a second user may desire weather and news information, and a third user may desire traffic, news and weather. For each of those three users, the detailed information desired may be different. Thus, the first user may desire traffic information for certain roadways, financial information for certain securities, and sports information for particular teams. The second user may desire to obtain some of the same types of information, but the details may be different. In the present example, the second user may desire local news and weather for City X, while the third user may desire news and weather for a different location, City Y. The various user profiles are then administered either by the individual proxy multiplexors on the user machines, or through a server that is communication with each user's proxy multiplexor.

In the present invention, the service control component 80 is accessed via a user system that has a display, such as a VGA or SVGA type, and a screen. Preferably, the screen is capable of displaying and rendering animation and images fairly rapidly. The user system typically has a pointing device such as a mouse, track ball, joystick, etc. that controls the movements of a cursor across the screen. The user's system also has an alphanumeric input device such as a keyboard, a touch screen or a character recognition system that is used by the user for entering alphanumeric information and controlling keystroke sequences. The user's system preferably also has a processor that processes instructions and data to provide a graphical user interface to the WWW to the user. The graphical user interface used in the present invention is a modification of a WWW browser such as that shown in FIG. 4a. The user uses the pointing device and keyboard to interact with the WWW browser displayed on a screen. The user system further has a storage component that has read only memory and random access memory therein, for storing instructions and data used by the processor. Also, the system has an input/output unit connected to the processor. The input/output unit communicates with the server under the control of the processor and user interactions with the WWW browser. The connection of a separate processor-memory bus and a peripheral bus to the processor is presented as one example of a user system architecture; the present invention would work just as well with other system architectures such as the architecture that has a single bus connecting the processor, store and peripherals.

It will be apparent to those skilled in the art that many changes and substitutions can be made to the system and method described herein without departing from the spirit and scope of the invention as defined by the appended claims.

What is claimed is:

1. A computer readable medium having a computer program encoded thereon, comprising:
a first portion of said medium having a first program segment for facilitating the selection of preferences for information to be displayed as part of a service control component;
a second portion of said medium having a second program segment for receiving over a communication network information from a plurality of service providers in accordance with said selected preferences; and
a third portion of said medium having a third program segment for displaying said information within the service control component, wherein at least one of the plurality of service providers is represented in the service control component by a unique icon that includes real time status updates.

2. The computer readable medium of claim 1, wherein a proxy multiplexor aggregates the information received-from the plurality of service providers.

3. The computer readable medium of claim 1, wherein the service control component is configured in conjunction with a browser.

4. The computer readable medium of claim 3, wherein the service control component is an embedded control bar.

5. The computer readable medium of claim 1, wherein the service control component is an independent display object.

6. The computer readable medium of claim 1, wherein said unique icon is selectable by the user to retrieve additional information from a corresponding one of said service providers.

7. A service controller system for integrating information from a plurality of service providers, comprising:
a proxy multiplexor which receives information from the plurality of providers, wherein the proxy multiplexor aggregates the information from the plurality of providers; and
an end user service control component which receives information from the proxy multiplexor, wherein each respective provider is represented by an individual icon within the end user component, at least one of said icons displaying the most current information received from its associated provider.

8. The service controller system of claim 7, wherein at least one of the plurality of providers is an HTTP server.

9. The service controller system of claim 7, wherein the end user component is integrated as part of a browser.

10. The service controller system of claim 7, wherein the end user component is a standalone object.

11. The service controller system of claim 7, wherein new providers may be added for display in the user's end user component via a centralized server.

12. The service controller system of claim 11, wherein the centralized server is an HTTP server having SSL capabilities.

13. The service controller system of claim 7, further comprising a second end user component having individual icons representing others of the plurality of service providers, wherein both end user components receive information from the proxy multiplexor.

14. The service controller system of claim 7, wherein said individual icon may be selected to retrieve additional information from a corresponding one of said service providers.

15. A service controller system comprising:
a plurality of service providers that provide information and content to a plurality of users;
a proxy multiplexor for each of the plurality of users that receives information and content from the plurality of providers, wherein each proxy multiplexor aggregates the information and content from the plurality of providers for each user; and
an end user control component which continuously receives updated information and content from the proxy multiplexor, wherein each respective provider is represented by an individual icon within the end user component, each individual icon being updated whenever new information is provided from the respective service provider associated with that icon.

16. The service controller system of claim 15, wherein the end user component includes a display portion that contains the provider icons.

17. The service controller system of claim 15, wherein the end user component is integrated as part of a Web browser.

18. The service controller system of claim 15, wherein the end user component is a standalone display object.

19. The service controller system of claim 15, wherein new providers may be added for display in the user's end user component via a centralized server.

20. The service controller system of claim 19, wherein the centralized server is an HTTP server having SSL capabilities.

21. The service controller system of claim 15, wherein the proxy multiplexor is an executable running on a user's machine.

22. The service controller system of claim 15, wherein each individual icon is updated without action required of the user.

23. The service controller system of claim 15, wherein each individual icon provides an alert to the user when updated with new information.

24. A method for displaying content from a plurality of service providers as part of a service control component, comprising:
receiving from a user a selection of preferences for receiving and displaying the content;
receiving over a communication network the content from the plurality of service providers in accordance with the preferences; and
displaying the content in accordance with the preferences, wherein at least one of the plurality of service providers is represented in the service control component by a unique icon that includes real time updates comprising at least some of the received content.

25. The method of claim 24, wherein a proxy multiplexor aggregates the content received from the plurality of service providers.

26. The method of claim 24, wherein the service control component is configured in conjunction with a browser.

27. The method of claim 26, wherein the service control component is an embedded control bar.

28. The method of claim 24, wherein the service control component is an independent display object.

29. The method of claim 24, wherein said unique icon is selectable by the user to retrieve additional information from a corresponding one of said service providers.
